(19) United States
(12) Patent Application Publication
(10) Pub. No.: US 2024/0168427 A1
(43) Pub. Date: May 23, 2024

(54) TRANSPORT DEVICE AND IMAGE FORMING APPARATUS

(71) Applicant: FUJIFILM Business Innovation Corp., Tokyo (JP)

(72) Inventors: Hideki KUGE, Kanagawa (JP); Yoshiki Shimodaira, Kanagawa (JP); Masato Yamashita, Kanagawa (JP); Takayuki Ukawa, Kanagawa (JP); Kazuhiko Arai, Kanagawa (JP); Yutaka Kiuchi, Kanagawa (JP); Yasutaka Gotoh, Kanagawa (JP)

(73) Assignee: FUJIFILM Business Innovation Corp., Tokyo (JP)

(21) Appl. No.: 18/320,322

(22) Filed: May 19, 2023

(30) Foreign Application Priority Data
Nov. 22, 2022 (JP) 2022-186483

(51) Int. Cl. G03G 15/00; G03G 15/20

(52) U.S. Cl. CPC G03G 15/657; G03G 15/2064; G03G 2215/00409

(57) ABSTRACT

A transport device includes multiple rotation members that rotate, a cycle member that has a loop shape, and that is wound around the multiple rotation members to cycle together with rotation of the rotation members, at least one holding member that is attached to the cycle member, that cycles together with the cycle member, and that holds a leading end portion of a recording medium while being spaced apart from each other in a width direction when the leading end portion arrives at a holding position, and a deformation member that deforms the leading end portion in a thickness direction throughout the width direction by time when the leading end portion arrives at the holding position.

### CROSS-REFERENCE TO RELATED APPLICATIONS

This application is based on and claims priority under 35 USC 119 from Japanese Patent Application No. 2022-186483 filed Nov. 22, 2022.

### BACKGROUND

### (i) Technical Field

The present disclosure relates to a transport device and an image forming apparatus.

### (ii) Related Art

Japanese Unexamined Patent Application Publication No. 2014-151520 describes a sheet drying device that dries a sheet while transporting the sheet along a transport path. The sheet drying device includes a leading end gripping member attached to an endless chain, traveling along the transport path by rotating the chain, and holding a leading end of the sheet, a suction plate disposed along the transport path at a fixed distance from the chain to suck the back surface of the sheet, a leading end guide inclined toward the suction plate from the leading end of the sheet to come into contact with the back surface of the sheet until being sucked by the suction plate, and a drying member that dries the sheet transported along the transport path from the top surface of the sheet. Japanese Unexamined Patent Application Publication No. 2014-151520 also describes an inkjet recording device. The inkjet recording device includes an image recording portion including an inkjet head that ejects a water-based ultraviolet curable ink on the sheet, the sheet drying device that dries the sheet on which an image is recorded by the image recording portion while transporting the sheet along a predetermined transport path, an UV irradiation processing portion that performs a fixing operation on the sheet dried by the sheet drying device, and a sheet discharging portion that discharges the sheet that has undergone the fixing operation performed by the UV irradiation processing portion.

Japanese Unexamined Patent Application Publication No. 2009-292631 describes a sheet transport device that includes a first roller formed from an elastic member, a second roller formed from a solid member to form a nip between itself and the first roller, a tension roller disposed upstream from the second roller in a sheet transport direction, an endless belt disposed between the second roller and the tension roller under a predetermined tension, having multiple holes, and forming the nip together with the second roller, and a suction member that sucks air on the sheet transport side through the holes in the endless belt. The sheet transport device transports the sheet to the nip portion while causing the suction member to attract the sheet to the endless belt to curl the transported sheet while the sheet is passing through the nip portion. Japanese Unexamined Patent Application Publication No. 2009-292631 also describes an image forming apparatus that includes the sheet transport device.

Japanese Unexamined Patent Application Publication No. 2000-247493 describes an image forming apparatus that transports a recording medium and forms an image on the recording medium. The image forming apparatus includes a transportation force providing member that provides a transport force to the recording medium to transport the recording medium, a guide member that guides a leading end portion of the recording medium to which the transport force is provided by the transportation force providing member, and a moving member that moves the guide member at substantially the same speed as the speed at which the recording medium to which the transport force is provided is transported.

### SUMMARY

Aspects of non-limiting embodiments of the present disclosure relate to a structure including a circulating holding member that holds the leading end portion of a recording medium while being spaced apart from each other in a width direction to reduce deflection of the recording medium held by the holding member in the width direction compared to the case where the holding member holds the leading end portion of the recording medium in a flat position.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a transport device including multiple rotation members that rotate, a cycle member that has a loop shape, and that is wound around the multiple rotation members to cycle together with rotation of the rotation members, at least one holding member that is attached to the cycle member, that cycles together with the cycle member, and that holds a leading end portion of a recording medium while being spaced apart from each other in a width direction when the leading end portion arrives at a holding position, and a deformation member that deforms the leading end portion in a thickness direction throughout the width direction by time when the leading end portion arrives at the holding position.

### BRIEF DESCRIPTION OF THE DRAWINGS

Exemplary embodiments of the present disclosure will be described in detail based on the following figures, wherein:

FIG. 1 is a front view of a transport device and an image forming apparatus according to an exemplary embodiment of the present disclosure;

FIG. 2 is a perspective view of a structure of a relevant portion of the image forming apparatus in FIG. 1;

FIG. 3 is an enlarged view of a gripper in the image forming apparatus in FIG. 1 while holding a sheet;

FIG. 4A is a cross-sectional view of the gripper in the image forming apparatus in FIG. 1 in a closed state;

FIG. 4B is a cross-sectional view of the gripper in the image forming apparatus in FIG. 1 in an open state;

FIG. 5 is an enlarged view of a feeder portion of the image forming apparatus in FIG. 1;

FIG. 6 is a front view of a relevant portion of the image forming apparatus in FIG. 1;

FIG. 7 is a front view of a contact member of the image forming apparatus in FIG. 1;

FIG. 8 is a plan view of the contact member of the image forming apparatus in FIG. 1;

FIG. 9A is an enlarged view of the image forming apparatus in FIG. 1 in the state before a clip holds the leading end portion of the sheet;

FIG. 9B is an enlarged view of the image forming apparatus in FIG. 1 in the state where the clip raises the leading end portion of the sheet;

FIG. 9C is an enlarged view of the image forming apparatus in FIG. 1 in the state where the clip holds the leading end portion of the sheet;

FIG. 10 is a plan view of a contact member of the image forming apparatus in FIG. 1 according to a first modification example;

FIG. 11 is a front view of a contact member of the image forming apparatus in FIG. 1 according to a second modification example;

FIG. 12 is a front view of a contact member of the image forming apparatus in FIG. 1 according to a third modification example;

FIG. 13 is a front view of a contact member of the image forming apparatus in FIG. 1 according to a fourth modification example; and

FIG. 14 is a front view of a contact member of the image forming apparatus in FIG. 1 according to a fifth modification example.

### DETAILED DESCRIPTION

Examples of a transport device and an image forming apparatus according to an exemplary embodiment of the present disclosure are described.

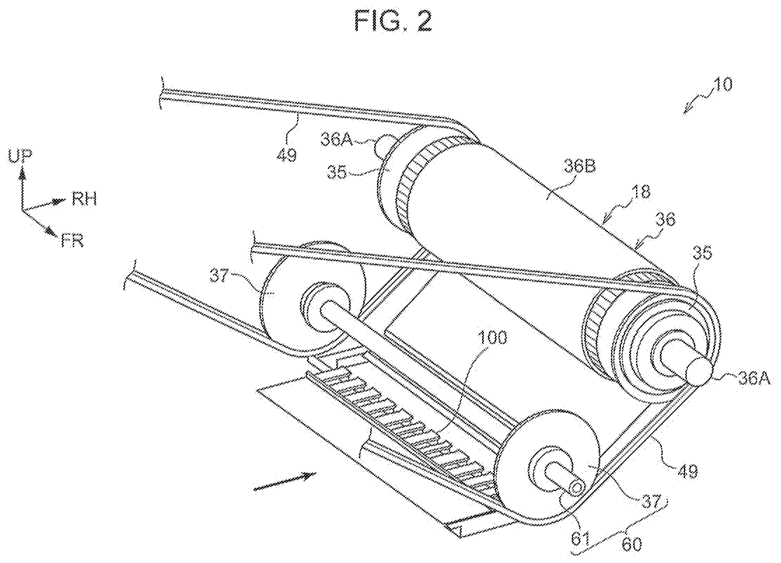

Throughout the drawings, an arrow UP denotes the upper side of the apparatus in the vertical direction. Throughout the drawings, an arrow RH points the right side of the apparatus in the horizontal direction when the apparatus is viewed from the front. As illustrated in FIG. 2, an arrow FR points the front side of the apparatus in the horizontal direction when the apparatus is viewed from the front.

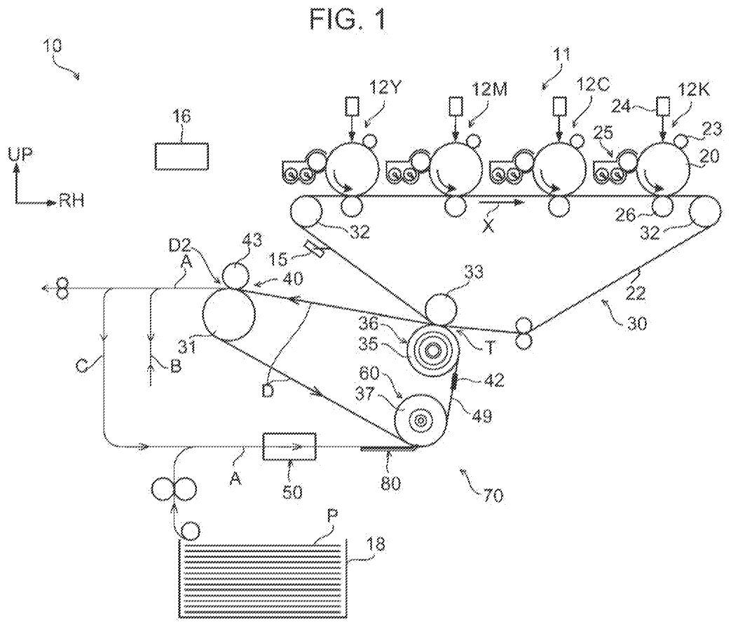

The vertical direction specified in the following description without any particular note refers to the upward and downward directions of the apparatus in FIG. 1. The lateral direction specified in the following description without any particular note refers to the leftward and rightward directions of the apparatus when the apparatus in FIG. 1 is viewed from the front. The depth direction specified in the following description without any particular note refers to the depth direction of the apparatus when the apparatus in FIG. 1 is viewed from the front.

Components denoted with the same reference signs throughout the drawings indicate the same or equivalent components. Redundant description or reference signs may be eliminated in the exemplary embodiments described below. All the drawings described below are schematic, and the dimensional relationships between the components or the ratios of the components illustrated in the drawings may differ from the actual ones. The dimensional relationships between the components or the ratios of the components between the drawings may differ from each other.

An image forming apparatus according to an exemplary embodiment of the present disclosure is described with reference to FIGS. 1 to 9C.

### Entire Structure of Image Forming Apparatus

First, a structure of an image forming apparatus 10 is described. FIG. 1 is a schematic front view of the image forming apparatus 10 according to the present exemplary embodiment.

As illustrated in FIG. 1, a transport device 70 includes sprockets (not illustrated) disposed at a transport drum 31, sprockets 35 included in a transfer drum 36, sprockets 37 included in a feed drum 60, chains 49 serving as examples of cycle members, grippers 42 serving as examples of holding members, and a sheet deforming portion 80 serving as an example of a deformation member. The sprockets disposed at the transport drum 31 according to the present exemplary embodiment, the sprockets 35 included in the transfer drum 36, and the sprockets 37 included in the feed drum 60 are examples of rotation members according to the present disclosure.

As illustrated in FIG. 1, the image forming apparatus 10 includes the transport device 70, an image forming portion 11, and a fixing portion 40. The image forming apparatus 10 also includes a transfer portion 30, a sheet feeding tray 18, a feeder portion 50 serving as an example of a feeder portion, and a controller 16.

The image forming portion 11 has a function of forming an image on a sheet P of a recording medium at an image forming position in a cycle path D of the chains 49, described below. More specifically, the image forming portion 11 has a function of forming an image on the sheet P by forming an image on a top surface (outer circumferential surface) of a transfer belt 22, described below, and transferring the formed image on the sheet P at a second transfer position T serving as the image forming position. This image forming portion 11 has, for example, four image forming units 12. The four image forming units 12 form, for example, toner images of different colors such as yellow (Y), magenta (M), cyan (C), and black (K).

Each image forming unit 12 includes a photoconductor drum 20. The photoconductor drum 20 is an example of an image carrier, and rotates while carrying the toner image to be transferred to the recording medium on its outer circumferential surface. Each image forming unit 12 has functions of forming a toner image on the photoconductor drum 20 of the corresponding color, and transferring the toner image to the transfer belt 22 at a first transfer position between the photoconductor drum 20 and a first transfer roller 26.

Each image forming unit 12 includes a charging device 23 that electrically charges the photoconductor drum 20, an exposure device 24 that forms a latent image on the electrically charged photoconductor drum 20, and a development device 25 that develops a latent image with toner.

The transfer portion 30 has a function of transferring the image (toner image) formed on the top surface of the transfer belt 22 to the sheet P. More specifically, the transfer portion 30 includes the transfer belt 22 serving as an example of a transfer body, the first transfer rollers 26, multiple rollers 32, a second transfer roller 33, the transfer drum 36 serving as an example of a drum, and a cleaner 15.

The transfer belt 22 is endless, and is wound and stretched around the multiple rollers 32 and the second transfer roller 33 to be in an inverted triangular position in a front view (when viewed from the front in the apparatus depth direction). The transfer belt 22 cycles in the direction of arrow X when at least one of the multiple rollers 32 actuates rotation. The image forming units 12 and the cleaner 15 for each color are disposed at the outer periphery of the transfer belt 22.

The multiple first transfer rollers 26 are disposed on the inner side of the transfer belt 22. Each first transfer roller corresponds to the corresponding color of the image. Specifically, in the present exemplary embodiment, the four first transfer rollers 26 correspond to the respective colors. Each first transfer roller 26 is disposed opposite to the photoconductor drum 20 of the corresponding color with the transfer belt 22 interposed therebetween.

The second transfer roller 33 is disposed on the inner side of the transfer belt 22.

The transfer drum 36 is disposed opposite to the second transfer roller 33 with the transfer belt 22 interposed therebetween. As illustrated in FIG. 2, the transfer drum 36 extends in the apparatus depth direction.

As illustrated in FIG. 2, the transfer drum 36 includes a shaft portion 36A extending in the apparatus depth direction, and a roller portion 36B serving as a cylindrical portion disposed at an intermediate portion of the shaft portion 36A in the axial direction. The sprockets 35 are attached to the shaft portion 36A at both ends in the axial direction. In other words, the roller portion 36B of the transfer drum 36 is disposed between the pair of sprockets 35.

The chains 49 are wound around the sprockets 35 on the transfer drum 36. Thus, the transfer drum 36 is driven to rotate with the cycle of the chains 49.

The roller portion 36B of the transfer drum 36 has recesses (not illustrated) to accommodate the grippers 42. The recesses each have a shape of a gutter extending from one end to the other end of the roller portion 36B in the axial direction (the same as the apparatus depth direction).

The transfer drum 36 forms a nip area between itself and the second transfer roller 33 that pushes the transfer belt 22 against the transfer drum 36. In other words, the nip area is formed between the transfer drum 36 and the transfer belt 22. The transfer drum 36 that is driven to rotate with the cycle of the chains 49 carries the transfer belt 22 at the nip area. While holding the sheet P transported by the chains 49 and the grippers 42 at the nip area between its outer circumferential portion and the transfer belt 22, and carrying the transfer belt 22, the transfer drum 36 transfers the toner image formed on the transfer belt 22 to the sheet P. The nip area formed between the transfer drum 36 and the transfer belt 22 serves as the second transfer position T serving as an example of the image forming position. Specifically, the image forming apparatus 10 according to the present exemplary embodiment transfers the toner image formed on the top surface of the transfer belt 22 by the image forming portion 11 at the second transfer position T to the top surface of the sheet P wound around the transfer drum 36.

The cleaner 15 is disposed downstream from the second transfer position T in the cycle direction of the transfer belt 22. The cleaner 15 includes a blade that is in contact with the outer circumferential surface of the transfer belt 22. This cleaner 15 removes, with the blade, toner and other residue (for example, paper dust when the sheet P is a paper sheet) that is left at a portion of the transfer belt 22 beyond the second transfer position T (nip area) in accordance with the cycle of the transfer belt 22.

As illustrated in FIG. 1, the sheet transport path A has a function of transporting the sheet P fed from the sheet feeding tray 18. The image forming apparatus 10 according to the present exemplary embodiment transports the sheet P fed from the sheet feeding tray 18 along the sheet transport path A. The sheet P passes the second transfer position T, and is discharged to a discharge tray (not illustrated).

The sheet transport path A diverges at a position downstream from a receiving position D2, described below, toward a direction-change path B to change the sheet transport direction. The direction-change path B merges with the sheet transport path A at a position further downstream in the transport direction. A path in the sheet transport path A between the direction-change path B and the cycle path D is a merging path where the transport path for the top surface of the sheet P and the transport path for the back surface merge with each other. The cycle path D is described below. These transport paths include multiple sheet transport rollers not illustrated. These rollers transport the sheet P along the transport paths.

The image forming apparatus 10 includes a fixing portion 40 downstream from the second transfer position T in the transport direction of the sheet P. This fixing portion 40 has a function of fixing the toner image transferred to the sheet P by the transfer portion 30 to the sheet P. More specifically, the fixing portion 40 includes a heating roller 43 serving as a heater that heats the transported sheet P while coming into contact with the sheet P, and a transport drum 31 serving as a pressing portion that presses the sheet P against the heating roller 43 while holding the sheet P between itself and the heating roller 43. The transport drum 31 and the heating roller 43 oppose each other with the sheet transport path A interposed therebetween. Specifically, the sheet P subjected to a fixing operation is transported to pass between the transport drum 31 and the heating roller 43.

The transport drum 31 has a function of pressing the sheet P while holding the sheet P between itself and the heating roller 43. More specifically, the transport drum 31 includes a shaft portion (not illustrated) extending in the apparatus depth direction, a roller portion (not illustrated) serving as a cylindrical portion disposed at an intermediate portion of the shaft portion in the axial direction, and recesses (not illustrated) formed in the outer surface of the roller portion. Sprockets, not illustrated, around which the chains 49 are wound are attached to both ends of the shaft portion of the transport drum 31 in the axial direction. In other words, the roller portion of the transport drum 31 is disposed between the pair of sprockets.

The chains 49 are wound around the sprockets of the transport drum 31. Thus, the transport drum 31 is driven to rotate in accordance with the cycle of the chains 49.

The roller portion of the transport drum 31 has recesses (not illustrated) that accommodate the grippers 42. The recesses each have a shape of the gutter extending from one end to the other end of the roller portion of the transport drum 31 in the axial direction (the same as the apparatus depth direction).

The heating roller 43 has a function of heating the sheet P. More specifically, the transport drum 31 includes a shaft portion, not illustrated, extending in the apparatus depth direction, and a roller portion, not illustrated, serving as a cylindrical portion disposed at an intermediate portion of the shaft portion in the axial direction.

The heating roller 43 forms a nip area to hold the sheet P between itself and the transport drum 31 by bringing the outer circumferential surface of its roller portion into contact with the outer circumferential surface of the roller portion of the transport drum 31. The nip area formed between the transport drum 31 and the heating roller 43 serves as a receiving position D2 serving as an example of an image receiving position.

### Image Forming Operation of Basic Image

Subsequently, a basic operation of the image forming apparatus 10 to form an image on the sheet P is schematically described.

Various operations of the image forming apparatus 10 are performed by the controller 16 included in the apparatus. When receiving an image forming instruction from the outside, the controller 16 operates the image forming portion 11. The controller 16 transmits image data subjected to image processing by an image signal processing portion (not illustrated) to the image forming portion 11. The image forming portion 11 first-transfers the toner image to the top surface of the transfer belt 22. Then, the image forming portion 11 second-transfers the toner image to the sheet P from the transfer belt 22 at the second transfer position T to form an image on the sheet P.

During double-sided printing, the transport direction of the sheet P that has passed the receiving position D2 described below is changed in the direction-change path B included in the transport path. The sheet P is then transported along the transport path C including multiple rollers (not illustrated), and then transported again to the sheet transport path A.

### Sprockets

The chains 49 are wound around the sprockets of the transport drum 31, the sprockets 35 on the transfer drum 36, and the sprockets 37 in the feed drum 60. The chains 49 are under a preset tension when being wound around these sprockets. As illustrated in FIG. 2, the sprockets 37 are disposed at both ends, in the axial direction, of a coupling shaft 61 extending in the apparatus depth direction. The feed drum 60 includes the coupling shaft 61 and the pair of sprockets 37. The sprockets 37, the sprockets 35, and the sprockets of the transport drum 31 are disposed sequentially from the upstream side in the sheet transport direction.

### Chains

The chains 49 have a function of transporting the sheet P held by the grippers 42 attached to the chains 49 in the cycle direction of the chains 49 (in the direction indicated with arrow D in the drawing) with the grippers 42. More specifically, the chains 49 have a loop shape, and wound and stretched around the sprockets of the transport drum 31, the sprockets 35, and the sprockets 37. More specifically, one of the chains 49 is wound around the sprocket of the transport drum 31, the sprocket 35, and the sprocket 37 disposed at the near side in the depth direction, and the other one of the chains 49 is wound around the sprocket of the transport drum 31, the sprocket 35, and the sprocket 37 disposed at the far side in the depth direction.

In the simple description below, the chains 49 indicate a pair of chains 49 disposed at the near side and far side in the depth direction. The chains 49 cycle in accordance with the driving rotation of any of the sprockets of the transport drum 31, the sprockets 35, and the sprockets 37. Any of the sprockets of the transport drum 31, the sprockets 35, and the sprockets 37 may actuate rotation, and the sprockets that do not actuate rotation are driven to rotate in accordance with the cycle of the chains 49.

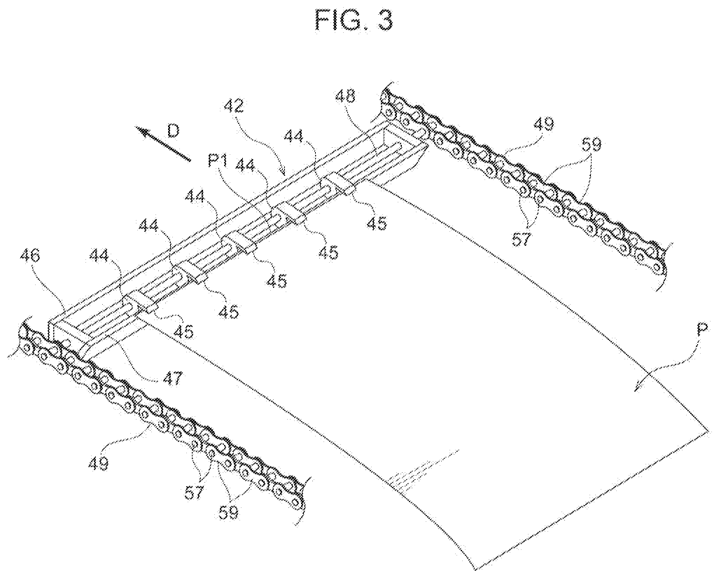

As illustrated in FIG. 3, each chain 49 includes roller links 59, including a combination of link plates and bushes including freely rotatable rollers, coupled with pin links 57. The multiple grippers 42 are attached to the chains 49 at preset intervals.

### Grippers

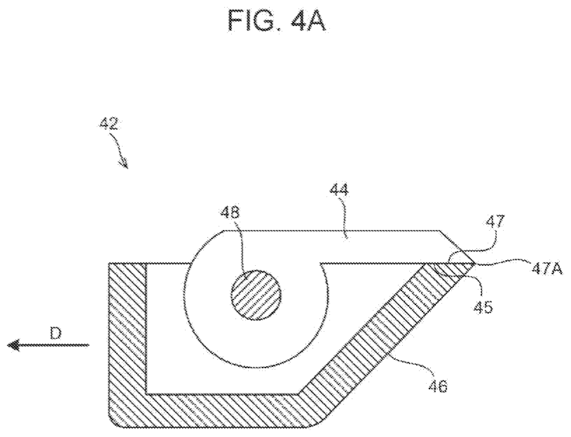

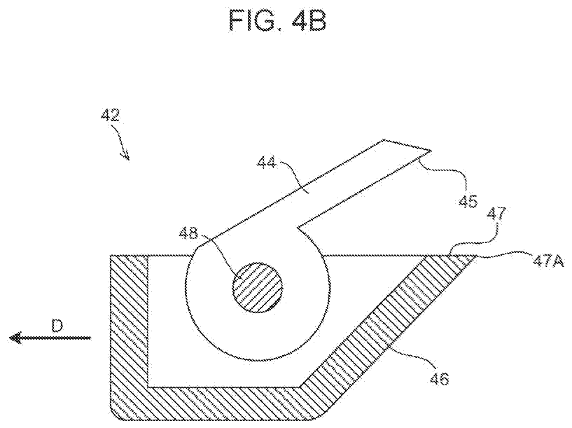

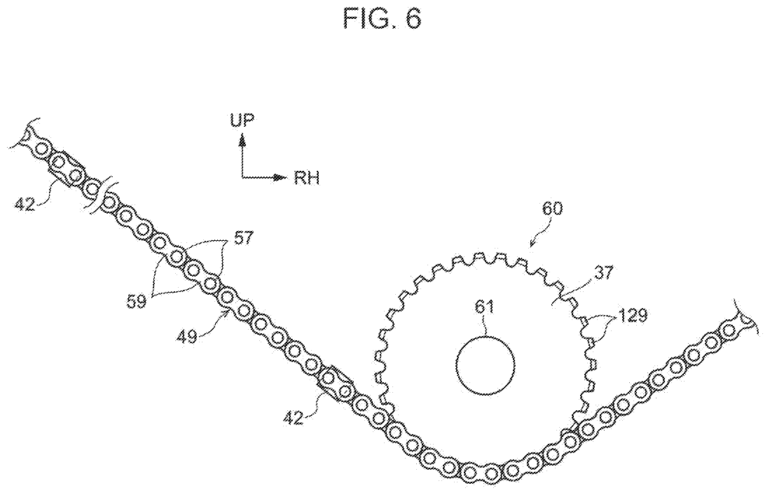

As illustrated in FIGS. 3, 4A, and 4B, the grippers 42 are attached to the chains 49, and have a function of cycling together with the chains 49 to hold the sheet P. As illustrated in FIG. 6, more specifically, the grippers 42 hold the leading end portion P1 (refer to FIG. 3) of the sheet P transported in an area where attachment portions of the chains 49 receiving the grippers 42 come into contact with the sprockets 37, and assist in transportation of the sheet P by cycling together with the chains 49. When the leading end portion P1 of the sheet P arrives at a holding position described below, the grippers 42 hold the leading end portion P1 while being spaced apart from each other in the width direction of the sheet P. The leading end portion P1 of the sheet P is also referred to as a leading end portion of the sheet P in the transport direction. The grippers 42 are attached to the chains 49 while being spaced preset intervals apart in the cycle direction of the chains 49. The chains 49 are in contact with the sprockets 37 while being engaged with the sprockets 37. Specifically, the attachment portions of the chains 49 are in contact with the sprockets 37 while being engaged with the sprockets 37. The engagement of the attachment portions of the chains 49 with the sprockets 37 may thus be also referred to as the contact of the attachment portions with the sprockets 37, and the engagement area may be also referred to as a contact area.

Each gripper 42 includes clips 44, a rectangular casing 46 covering the clip 44, and a shaft 48 extending in the depth direction.

The clips 44 are fixed to the shaft 48 to rotate together with the shaft 48. The clips 44 are arranged on the shaft 48 while being spaced apart from each other in the axial direction (the same as the apparatus depth direction) of the shaft 48 (refer to FIG. 3). In the state of holding the sheet P, the multiple clips 44 hold the sheet P at multiple portions of the sheet P in the width direction of the sheet P.

The casing 46 has a length in the apparatus depth direction, and is held by the shaft 48. This casing 46 rotates independently from the rotation of the clips 44. The casing 46 covers the clips 44 on the upstream and downstream sides in the sheet transport direction and the back surface of the sheet. Herein, “the back surface” refers to the surface of the sheet P on which no image is formed. In such a structure, leading end portions 45 of the clips 44 and a fixed hook 47 of the casing 46 at the rear end hold the leading end portion P1 of the sheet P in the transport direction. As illustrated in FIG. 4A and FIG. 4B, the fixed hook 47 has a leading end portion 47A.

The shaft 48 is held by the pair of chains 49 at both ends in the depth direction. When these chains 49 cycle, the shaft 48 fixed to the pair of chains 49 also cycles. Thus, the grippers 42 cycle along the preset cycle path D (refer to FIG. 1) while being held by the pair of chains 49.

As illustrated in FIG. 1, the cycle path D of the chains 49 partially overlaps the sheet transport path A when the image forming apparatus 10 is viewed from the front. More specifically, the cycle path D overlaps the sheet transport path A between a portion beyond the contact point in the outer peripheries of the sprockets 37 and the sheet transport path A and the receiving position D2 described below.

The grippers 42 hold the leading end portion P1 of the sheet P while having the leading end portions 45 in the clips 44 and the fixed hook 47 of the casing 46 approaching each other at the point where the sheet transport path A and the cycle path D start overlapping each other. The holding position in the cycle path D where the grippers 42 hold the sheet P is a delivery position D1 where the sheet P is fed from the sheet transport path A to the grippers 42.

At an end point where the cycle path D and the sheet transport path A finish overlapping each other, the leading end portions 45 of the clips 44 and the fixed hook 47 of the casing 46 are spaced apart from each other, and the leading end portion P1 of the sheet P is released. The release position in the cycle path D where the grippers 42 release the sheet P is a receiving position D2 where the sheet P is handed over from the grippers 42 to the sheet transport path A.

In the present exemplary embodiment, the cycle speed of the grippers 42 is the same as the rotation speed of each sprocket.

### Feeder Portion

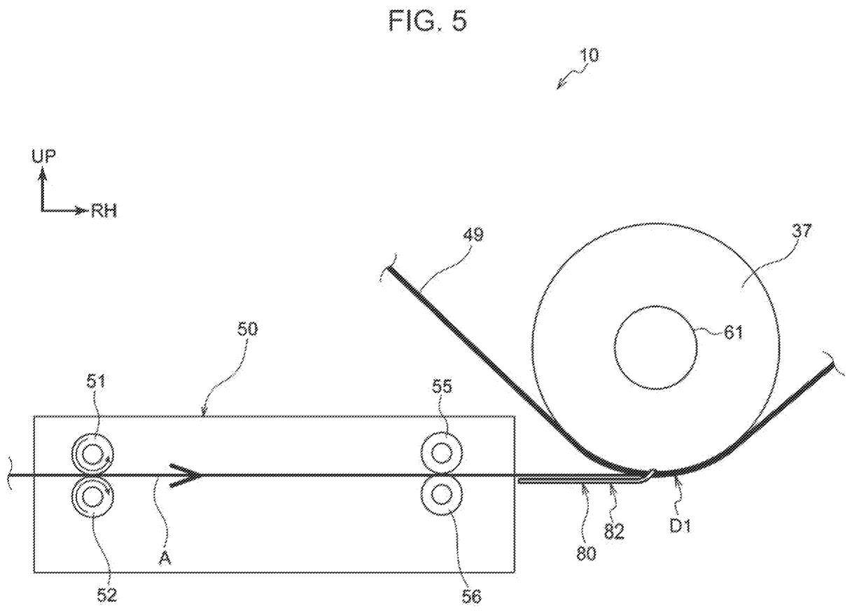

The feeder portion 50 has a function of feeding the sheet P to the delivery position D1 serving as the holding position where the grippers 42 hold the sheet P. More specifically, as illustrated in FIG. 1, the feeder portion 50 is disposed in the merging path in the sheet transport path A between the direction-change path B and the delivery position D1. As illustrated in FIG. 5, the feeder portion 50 includes transport rollers 51 and 52 and registration rollers 55 and 56. Each roller is disposed on the upper side or lower side of the sheet transport path A. The transport roller 51 on the upper side and the transport roller 52 on the lower side form a pair to rotate to transport the sheet P, and the registration roller 55 on the upper side and the registration roller 56 on the lower side form a pair to rotate to transport the sheet P.

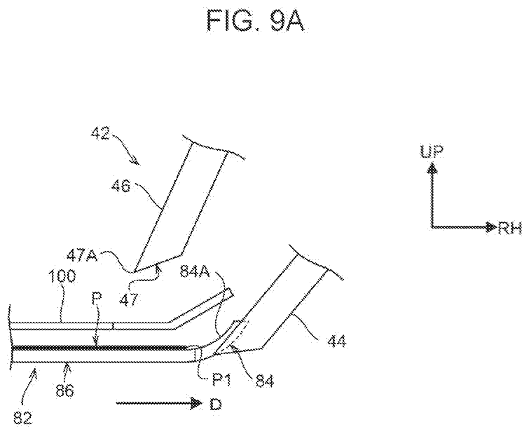

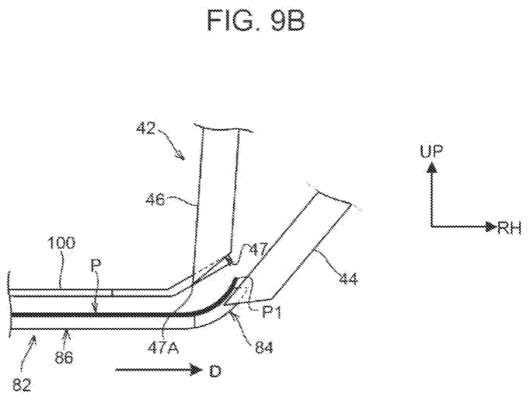

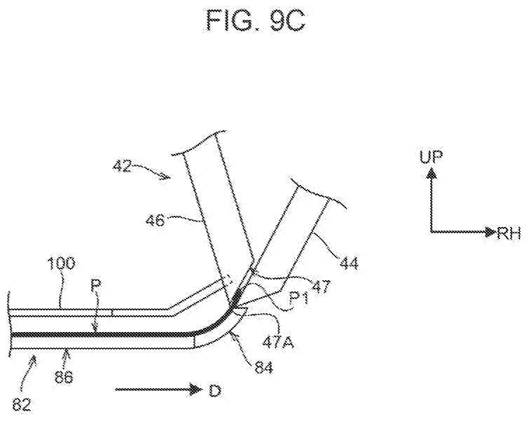

As illustrated in FIGS. 9A, 9B, and 9C, the sheet P fed from the feeder portion 50 is held by the fixed hook 47 of the casing 46 and the leading end portions 45 of the clips 44 in the grippers 42 on the circumferences of the sprockets 37 in FIG. 5. While moving along the cycle path D, the grippers 42 are provided at the timing when the leading end portion P1 of the sheet P is transported thereto. At this time, as illustrated in FIG. 9A, the casing 46 and the clips 44 are in the open state. As illustrated in FIG. 9B, while the grippers 42 move along the cycle path D in accordance with the timing at which the sheet P is fed from the feeder portion 50 to the delivery position D1, the casing 46 and the clips 44 gradually move toward each other. Then, the leading end portions 45 of the clips 44 raise the leading end portion P1 of the sheet P from the sheet transport path A. As illustrated in FIG. 9C, the leading end portion P1 of the sheet P is further raised by the clips 44, and is fed from the sheet transport path A to the cycle path D while being held by the fixed hook 47 of the casing 46 and the leading end portions 45 of the clips 44. Thereafter, the sheet P is transported by the grippers 42 along the cycle path D.

As illustrated in FIG. 1, after being handed over to the cycle path D, the sheet P is inverted along the outer periphery of the transfer drum 36. The sheet P is then transported to the second transfer position T on the outer periphery of the transfer drum 36. Specifically, in the process of inverting the sheet P along the cycle path and the outer periphery of the transfer drum 36, the sheet P passes through the second transfer position T.

The surface of the sheet P facing the second transfer roller 33 when passing the second transfer position T serves as an image receiving surface, or a top surface. In other words, at the feeder portion 50 and the delivery position D1, the sheet P is transported while having the back surface or a no-image receiving surface facing upward.

The sheet P that has passed the second transfer position T is handed over from the cycle path D to the sheet transport path A. A diverging point between the cycle path D and the sheet transport path A serves as the receiving position D2. At the receiving position D2, the grippers 42 holding the leading end portion P1 of the sheet P are released, and the sheet P is handed over from the cycle path D to the sheet transport path A.

### Structure of Relevant Portion

Subsequently, the structure of the relevant portion according to the present exemplary embodiment is described.

The transport device 70 according to the present exemplary embodiment is a device that transports the sheet P, and has a function of transporting the sheet P from the delivery position D1 to the receiving position D2, as described above. The transport device 70 includes the sprockets in the transport drum 31, the sprockets 35, the sprockets 37, the chains 49, the grippers 42, and the sheet deforming portion 80.

The sheet deforming portion 80 has a function of deforming the leading end portion P1 of the sheet P in the thickness direction throughout the width direction of the sheet P by the time when the leading end portion P1 arrives at the holding position where the leading end portion P1 is held by the grippers 42. Here, deforming the leading end portion P1 of the sheet P in the thickness direction refers to deforming the leading end portion P1 in the thickness direction with respect to the portion of the sheet P other than the leading end portion P1, that is, with respect to the intermediate portion and the rear end portion of the sheet P in the transport direction. Although the leading end portion P1 of the sheet P may be deformed either upward (one side of the thickness direction of the sheet P) or downward (the other side of the thickness direction of the sheet P), the leading end portion P1 of the sheet P is deformed upward in the present exemplary embodiment.

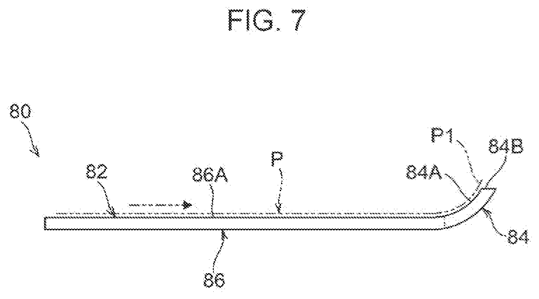

As illustrated in FIGS. 7 and 9A, the sheet deforming portion 80 includes a contact member 82 that comes into contact with the sheet P to deform the leading end portion P1 of the sheet P. This contact member 82 includes a guide portion 84 that deforms the leading end portion P1 of the sheet P while guiding the leading end portion P1 to the holding position. The contact member 82 also includes a support portion 86 that supports the sheet P fed from the feeder portion 50. The guide portion 84 and the support portion 86 according to the present exemplary embodiment are plates. The guide portion 84 in the contact member 82 is connected to the end portion of the support portion 86 in the direction in which the sheet P is fed (transport direction). In other words, the guide portion 84 extends from the end portion of the support portion 86 in the direction in which the sheet P is transported. Here, a top surface 86A of the support portion 86 and a top surface 84A of the guide portion 84 are continuous with each other. The top surface 86A of the support portion 86 is a planar surface and extends in the direction in which the sheet P is transported. The top surface 84A of the guide portion 84 extends obliquely upward from the end portion of the top surface 86A of the support portion 86 in the direction in which the sheet P is transported. In the present exemplary embodiment, the top surface 84A of the guide portion 84 is a curved surface having an arc shape, but the present disclosure is not limited to this. The top surface 84A of the guide portion 84 may be a slope extending obliquely.

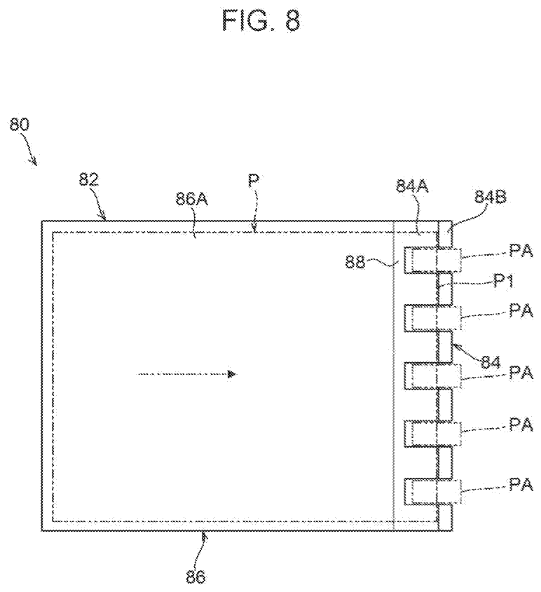

As illustrated in FIG. 8, a leading end portion 84B of the guide portion 84 has cutouts 88 through which the clips 44 of the grippers 42 pass. The leading end portion 84B of the guide portion 84 indicates the end portion of the guide portion 84 in the direction in which the sheet P is transported. The cutouts 88 are formed at the leading end portion 84B of the guide portion 84 in passage areas PA through which the multiple clips 44 pass.

As illustrated in FIGS. 9A to 9C, in the present exemplary embodiment, a guide member 100 is located to face the contact member 82 with the sheet transport path A for the sheet P interposed therebetween. More specifically, the guide member 100 is disposed above the contact member 82. As in the case of the contact member 82, the guide member 100 has cutouts (refer to FIG. 2) at the end portion in the direction in which the sheet P is transported. The clips 44 pass through the cutouts in the guide member 100.

### Operations

The operations of the present exemplary embodiment are described now.

As illustrated in FIG. 9A, the transport device 70 according to the present exemplary embodiment supports the sheet P fed from the feeder portion 50 with the support portion 86 of the contact member 82. When the leading end portion P1 of the sheet P passes over the guide portion 84 (the top surface 84A), the leading end portion P1 of the sheet P is raised along the guide portion 84 (refer to FIG. 9B). Specifically, the leading end portion P1 of the sheet P curves up (is deformed to curve). The guide portion 84 is located downstream from the holding position in the direction in which the sheet P is transported. Thus, the leading end portion P1 of the sheet P is deformed to curve in the thickness direction throughout the width direction of the sheet P before the leading end portion P1 of the sheet P arrives at the holding position where the clips 44 hold the sheet P. Thus, when the leading end portion P1 of the sheet P is deformed to curve, the stiffness of the leading end portion P1 in the width direction improves. In the transport device 70 according to the present exemplary embodiment, in the state where the leading end portion P1 of the sheet P is deformed to curve, that is, in the state where the stiffness of the leading end portion P1 in the width direction improves, the leading end portion P1 arrives at the holding position, and is held by the clips 44 of the grippers 42 (refer to FIG. 9C). Thus, the transport device 70 according to the present exemplary embodiment reduces deflection, in the width direction, of the leading end portion P1 of the sheet P held by the clips 44 of the grippers 42 further than when, for example, the leading end portion P1 of the sheet P is held in a flat state by the clips 44 of the grippers 42.

In the transport device 70, the contact member 82 comes into contact with the sheet P to deform the leading end portion P1 to curve while supporting the sheet P. Thus, the transport device 70 may further reduce variation of the deformation amount of the leading end portion P1 than, for example, a structure that deforms the leading end portion P1 without being in contact with the sheet P.

In the transport device 70, the contact member 82 includes the guide portion 84 having a function of deforming the leading end portion P1 of the sheet P to curve while guiding the leading end portion P1. Thus, the transport device 70 may further save the space than, for example, a structure that separately performs deformation of the leading end portion P1 of the sheet P and guiding of the leading end portion P1 to the holding position.

In the transport device 70, the contact member 82 includes a support portion 86 that supports the sheet P fed from the feeder portion 50, and the guide portion 84 connected to the end portion of the support portion 86 in the direction in which the sheet P is transported. Thus, the transport device 70 may further reduce the number of components than, for example, a structure separately including the support portion 86 and the guide portion 84.

In the transport device 70, the leading end portion 84B of the guide portion 84 has the cutouts 88 through which the clips 44 pass. Thus, the leading end portion 84B of the guide portion may be brought closer to the holding position. Thus, the transport device 70 may further reduce deflection, in the width direction, of the sheet P held by the clips 44 of the grippers 42 than a structure where the guide portion 84 does not have the cutouts 88 at the leading end portion 84B, that is, a structure where the leading end portion 84B is spaced apart from the cycle path of the clips 44.

The image forming apparatus 10 according to the present exemplary embodiment includes the transport device 70. Thus, the image forming apparatus 10 further reduces deflection of the sheet P in the width direction than, for example, a structure where the grippers 42 hold the leading end portion P1 of the sheet P in a flat state. In this state, the sheet P arrives at the fixing portion 40, and the fixing portion 40 fixes the toner image on the sheet P. At this time, the image forming apparatus 10 reduces deflection of the sheet P in the width direction, and thus reduces creases formed in the sheet P during the fixing operation.

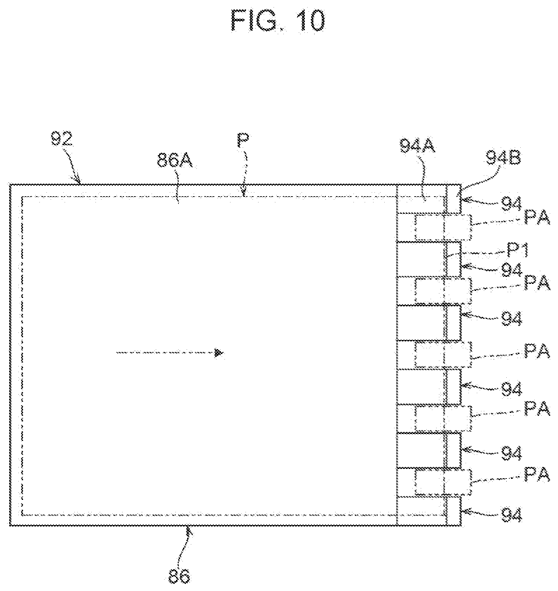

Although the leading end portion 84B of the guide portion 84 has the cutouts 88 in the above exemplary embodiment, the present disclosure is not limited to this structure. For example, as in a contact member 92 illustrated in FIG. 10, multiple guide portions 94 may be arranged at the end portion of the support portion 86 while being spaced apart from each other in the apparatus depth direction to keep clear of the passage areas PA where the clips 44 pass. In this case, the clips 44 pass between the guide portions 94 adjacent in the apparatus depth direction. This structure may further reduce deflection, in the width direction, of the sheet P held by the grippers 42 than a structure where a leading end portion 94B of the guide portion 94 in the direction in which the sheet P is fed is located at the near side (downstream) from the passage areas PA of the clips 44 in the direction in which the sheet P is transported. As illustrated in FIG. 10, the guide portion 94 has a top surface 94A.

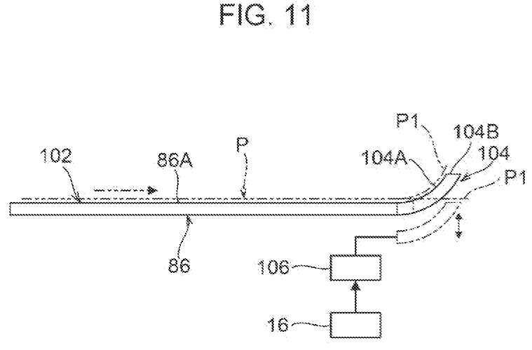

In the image forming apparatus 10 according to the above exemplary embodiment, the support portion 86 and the guide portion 84 included in the contact member 82 are integrated, but the present disclosure is not limited to this structure. For example, as in a contact member 102 illustrated in FIG. 11, the support portion 86 and a guide portion 104 included in the contact member 102 may be separate bodies. More specifically, the contact member 102 is attached to a housing of the image forming apparatus 10 or a bracket coupled to the housing while having the support portion 86 fixed to the housing of the image forming apparatus 10 or the bracket coupled to the housing and having the guide portion 104 switchable between a position where it is in contact with the fixed support portion 86 (indicated with the solid line in FIG. 11) and a position where it is away from the support portion 86 (indicated with the two-dot chain line in FIG. 11). This positional switch of the guide portion 104 (in other words, switch between positions) is performed by a movement device 106. A known movement device including, for example, a motor or cylinder as a driving source may be used as an example of the movement device 106. This movement of the guide portion 104 performed by the movement device 106 is controlled by the controller 16. When an image is formed on one surface of the sheet P (in other words, when an image is fixed to one surface of the sheet P after passing through the fixing portion 40), the controller 16 controls the movement device 106 to bring the guide portion 104 into contact with the support portion 86 to deform the leading end portion P1 of the sheet P to curve throughout the width direction. On the other hand, when no image is formed on the sheet P, the controller 16 controls the movement device 106 to keep the guide portion 104 away from the support portion 86 not to deform the leading end portion P1 of the sheet P to curve. In this manner, the controller 16 may select whether to operate the contact member 102. Thus, the recording medium held at the holding position is more easily allowed to cycle than in a structure that deforms the leading end portion P1 to curve regardless of whether the sheet P has an image.

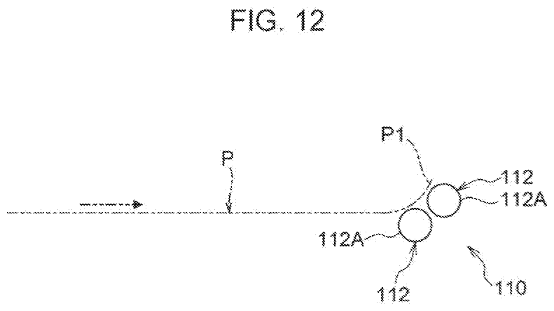

Although the image forming apparatus 10 according to the above exemplary embodiment includes the sheet deforming portion 80 as an example of a deformation member that deforms the leading end portion P1 of the sheet P in the thickness direction, the present disclosure is not limited to this structure. Instead, the image forming apparatus 10 may include, for example, a sheet deforming portion 110 illustrated in FIG. 12. This sheet deforming portion 110 includes a contact member 112. The contact member 112 is a roller that rotates about the apparatus depth direction, serving as an axis of rotation direction. The contact member 112 is disposed between the feeder portion 50 and the holding position, and the leading end portion P1 of the sheet P comes into contact with an outer circumferential surface 112A. The outer circumferential surface 112A of the contact member 112 is an example of a guide portion, and guides the leading end portion P1 that is in contact with the outer circumferential surface 112A obliquely upward. Multiple contact members 112 may be arranged in the direction in which the sheet P is transported. Arranging multiple contact members 112 more easily deforms the leading end portion P1 of the sheet P to curve in the thickness direction throughout the width direction. The contact members 112 may be arranged while being spaced apart in the apparatus depth direction to keep clear of the passage areas PA where the clips 44 pass. When, as described above, roller members are used as the contact members 112, and when the leading end portion P1 of the sheet P comes into contact with the outer circumferential surface 112A of the contact member 112, the contact member 112 rotates, and the leading end portion P1 is raised obliquely upward. Specifically, the leading end portion P1 is deformed to curve. The leading end portion P1 that is deformed to curve is held by the clips 44. Here, the sheet deforming portion 110 may more smoothly feed the sheet P from the feeder portion 50 to the holding position than a structure including unrotatable roller members. When the multiple contact members 112 are arranged in the direction in which the sheet P is transported, the sheet P may be more smoothly fed to the holding position than in, for example, a structure including only one contact member 112 in the direction in which the sheet P is transported. Furthermore, a structure where the clips 44 pass between the contact members 112 adjacent in the apparatus depth direction may further reduce deflection, in the width direction, of the sheet P held by the grippers 42 than in a structure where the contact members 112 are disposed on the nearer side from the passage areas PA of the clips 44 in the direction in which the sheet P is fed.

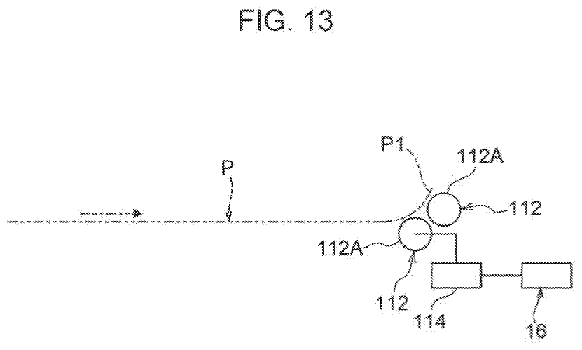

As described above, when multiple contact members 112 are included, one of the contact members 112 may actuate rotation. As illustrated in FIG. 13, when a rotation actuator 114 is coupled to the shaft portion of the contact member 112, and the driving force of the rotation actuator 114 is input to the contact member 112, the contact member 112 may rotate. The rotation actuator 114 is controlled by the controller 16. More specifically, the driving force input from the rotation actuator 114 to the contact member 112 is controlled by the controller 16. In this case, when one of the contact members 112 actuates rotation, the sheet P may be more smoothly fed to the holding position than in a structure where all the contact members 112 rotate freely. In addition, the contact members 112 may be retractable from the transport path of the sheet P. When the sheet P has an image on one surface, the contact members 112 may deform the leading end portion P1 of the sheet P to curve, and when the sheet P has no image, the contact members 112 may be retracted not to deform the leading end portion P1 of the sheet P to curve. The retraction of the contact members 112 is controlled by the controller 16.

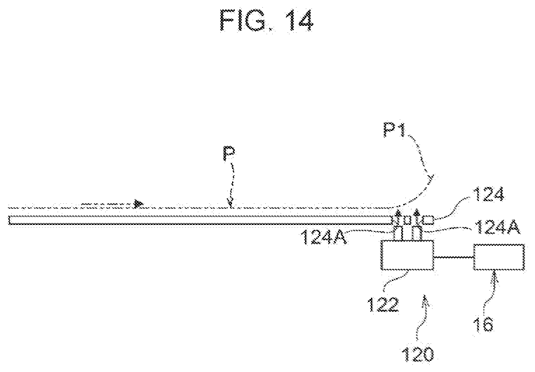

Although the image forming apparatus 10 according to the above exemplary embodiment includes the sheet deforming portion 80 as an example of a deformation member that deforms the leading end portion P1 of the sheet P in the thickness direction, the present disclosure is not limited to this structure. Instead, the image forming apparatus 10 may include, for example, a sheet deforming portion 120 illustrated in FIG. 14. The sheet deforming portion 120 includes a blower 122 that blows gas on the sheet P to deform the leading end portion P1. The blower 122 blows the gas at the rate controlled by the controller 16, and blows the gas, through through-holes 124A formed in a planar support portion 124 that supports the sheet P, on the sheet P that passes over the planar support portion 124. In FIG. 14, the support portion 124 has two through-holes 124A in the direction in which the sheet P is transported. Instead, one through-hole 124A or three or more through-holes 124A may be arranged in the direction in which the sheet P is transported. Multiple through-holes 124A may be arranged in the apparatus depth direction, or the through-hole 124A may be a continuous slit. The structure including the blower 122 may further efficiently adjust the amount by which the leading end portion P1 of the sheet P is deformed to curve by adjusting the rate at which the gas is blown on the sheet P than a structure including a member that deforms the sheet P to curve at a fixed amount, for example, a member that deforms the sheet P to curve at a fixed angle. For example, the amount at which the leading end portion P1 of the sheet P is deformed to curve may vary depending on the type of the sheet P. Instead, the blower 122 may blow the gas continuously from the start to the end of a print job, or continuously from when the sheet P is fed from the feeder portion 50 until when the sheet P is held by the grippers 42. In addition, the controller 16 may control the blower 122 to operate the blower 122 when the sheet P has an image on at least one surface, and not to operate the blower 122 when the sheet P has no image or a blank sheet.

In the image forming apparatus 10 according to the above exemplary embodiment, the leading end portion P1 of the sheet P is deformed to curve by a blow of the gas from the blower 122, but the present disclosure is not limited to this structure. For example, the image forming apparatus 10 may include a suction portion to deform the leading end portion P1 of the sheet P to curve with suction from the suction portion.

The image forming apparatus 10 according to the present exemplary embodiment includes the chains as examples of cycle members, and the sprockets as examples of rotation members. However, the present disclosure is not limited to this structure. For example, the image forming apparatus 10 may include a timing belt having protrusions and recesses on the inner periphery as an example of the cycle member, or a timing pulley (a pulley having protrusions and recesses on the outer periphery) as an example of the rotation member. Instead, the image forming apparatus 10 may include a belt as an example of the cycle member, and a pulley that cycles the belt with friction as an example of the rotation member. In this structure, the belt cycles while the pulley rotates in contact with the belt instead of being engaged with the belt.

The image forming apparatus 10 according to the present exemplary embodiment includes a photoelectric image forming portion that forms an image on a recording medium with toner as the image forming portion 11, but the present disclosure is not limited to this. For example, the image forming apparatus 10 may include an inkjet image forming portion that forms an image on a recording medium with ink as the image forming portion.

The present disclosure is not limited to the above exemplary embodiments, and may be modified, changed, or improved in various manners within the scope not departing from the gist of the disclosure. For example, any two or more of the modification examples described above may be combined as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A transport device, comprising:
a plurality of rotation members that rotate;
a cycle member that has a loop shape, and that is wound around the plurality of rotation members to cycle together with rotation of the rotation members;
at least one holding member that is attached to the cycle member, that cycles together with the cycle member, and that holds a leading end portion of a recording medium while being spaced apart from each other in a width direction when the leading end portion arrives at a holding position; and
a deformation member that deforms the leading end portion in a thickness direction throughout the width direction by time when the leading end portion arrives at the holding position.
   (((2)))

The transport device according to (((1))), wherein the deformation member includes a contact member that deforms the leading end portion by coming into contact with the recording medium.

(((3)))

The transport device according to (((2))), wherein the contact member includes at least one guide portion that deforms the leading end portion of the recording medium while guiding the leading end portion to the holding position.

(((4)))

The transport device according to (((3))),
wherein the contact member includes:
   a support portion that supports the recording medium fed from a feeder portion; and
   the guide portion that is connected to an end portion of the support portion in a direction in which the recording medium is fed.
      (((5)))

The transport device according to (((3))) or (((4))),
wherein the holding member includes a plurality of holders arranged at intervals in an axial direction of the rotation members to hold the leading end portion,
wherein the guide portion extends in the axial direction, and
wherein the guide portion has cutouts through which the holders pass at an end portion nearer the holding position.
   (((6)))

The transport device according to (((3))) or (((4))),
wherein the holding member includes a plurality of holders arranged at intervals in an axial direction of the rotation member to hold the leading end portion,
wherein the guide portion includes a plurality of guide portions arranged at intervals in the axial direction, and
wherein the holders pass between the guide portions adjacent to each other in the axial direction.
   (((7)))

The transport device according to (((3))),
wherein the contact member includes at least one roller member that is rotatable about an axial direction of the rotation member, serving as an axis of rotation, and
wherein the leading end portion of the recording medium comes into contact with an outer circumferential surface of the roller member serving as the guide portion.
   (((8)))

The transport device according to (((7))),
wherein the at least one roller member includes a plurality of roller members arranged in a direction in which the recording medium is fed.
   (((9)))

The transport device according to (((7))) or (((8))),
wherein the roller member actuates rotation in a direction in which the recording medium is fed.
   (((10)))

The transport device according to any one of (((7))) to (((9))),
wherein the holding member includes a plurality of holders arranged at intervals in the axial direction of the rotation member to hold the leading end portion, and
wherein the at least one roller member includes a plurality of roller members arranged in the axial direction to keep clear of an area where the holders pass.
   (((11)))

The transport device according to (((1))),
wherein the deformation member includes a blower that blows gas on the recording medium to deform the leading end portion.
   (((12)))

An image forming apparatus, comprising:
the transport device according to any one of (((1))) to (((11)));
an image forming portion that forms an image on the recording medium held by the holding member at an image forming position in a cycle path of the cycle member of the transport device; and
a fixing portion that fixes the image on the recording medium at the fixing position in the cycle path.
   (((13)))

The image forming apparatus according to (((12))), comprising:
a controller that controls the deformation member of the transport device,
wherein the controller causes the deformation member to deform the leading end portion of the recording medium in the thickness direction throughout the width direction when the recording medium has an image on one surface, and
wherein the controller controls the deformation member not to operate the deformation member when the recording medium has no image.

What is claimed is:

1. A transport device, comprising:
a plurality of rotation members that rotate;
a cycle member that has a loop shape, and that is wound around the plurality of rotation members to cycle together with rotation of the rotation members;
at least one holding member that is attached to the cycle member, that cycles together with the cycle member, and that holds a leading end portion of a recording medium while being spaced apart from each other in a width direction when the leading end portion arrives at a holding position; and
a deformation member that deforms the leading end portion in a thickness direction throughout the width direction by time when the leading end portion arrives at the holding position.

2. The transport device according to claim 1, wherein the deformation member includes a contact member that deforms the leading end portion by coming into contact with the recording medium.

3. The transport device according to claim 2, wherein the contact member includes at least one guide portion that deforms the leading end portion of the recording medium while guiding the leading end portion to the holding position.

4. The transport device according to claim 3,
wherein the contact member includes:
a support portion that supports the recording medium fed from a feeder portion; and
the guide portion that is connected to an end portion of the support portion in a direction in which the recording medium is fed.

5. The transport device according to claim 3,
wherein the holding member includes a plurality of holders arranged at intervals in an axial direction of the rotation members to hold the leading end portion,
wherein the guide portion extends in the axial direction, and
wherein the guide portion has cutouts through which the holders pass at an end portion nearer the holding position.

6. The transport device according to claim 3,
wherein the holding member includes a plurality of holders arranged at intervals in an axial direction of the rotation member to hold the leading end portion,
wherein the at least one guide portion includes a plurality of guide portions arranged at intervals in the axial direction, and
wherein the holders pass between the guide portions adjacent to each other in the axial direction.

7. The transport device according to claim 3,
wherein the contact member includes at least one roller member that is rotatable about an axial direction of the rotation member, serving as an axis of rotation, and
wherein the leading end portion of the recording medium comes into contact with an outer circumferential surface of the roller member serving as the guide portion.

8. The transport device according to claim 7,
wherein the at least one roller member includes a plurality of roller members arranged in a direction in which the recording medium is fed.

9. The transport device according to claim 7,
wherein the roller member actuates rotation in a direction in which the recording medium is fed.

10. The transport device according to claim 7,
wherein the at least one holding member includes a plurality of holders arranged at intervals in the axial direction of the rotation member to hold the leading end portion, and
wherein the at least one roller member includes a plurality of roller members arranged in the axial direction to keep clear of areas where the holders pass.

11. The transport device according to claim 1,
wherein the deformation member includes a blower that blows gas on the recording medium to deform the leading end portion.

12. An image forming apparatus, comprising:
the transport device according to claim 1;
an image forming portion that forms an image on the recording medium held by the holding member at an image forming position in a cycle path of the cycle member of the transport device; and
a fixing portion that fixes the image on the recording medium at the fixing position in the cycle path.

13. An image forming apparatus, comprising:
the transport device according to claim 2;
an image forming portion that forms an image on the recording medium held by the holding member at an image forming position in a cycle path of the cycle member of the transport device; and
a fixing portion that fixes the image on the recording medium at the fixing position in the cycle path.

14. An image forming apparatus, comprising:
the transport device according to claim 3;
an image forming portion that forms an image on the recording medium held by the holding member at an image forming position in a cycle path of the cycle member of the transport device; and
a fixing portion that fixes the image on the recording medium at the fixing position in the cycle path.

15. An image forming apparatus, comprising:
the transport device according to claim 4;
an image forming portion that forms an image on the recording medium held by the holding member at an image forming position in a cycle path of the cycle member of the transport device; and
a fixing portion that fixes the image on the recording medium at the fixing position in the cycle path.

16. An image forming apparatus, comprising:
the transport device according to claim 5;
an image forming portion that forms an image on the recording medium held by the holding member at an image forming position in a cycle path of the cycle member of the transport device; and
a fixing portion that fixes the image on the recording medium at the fixing position in the cycle path.

17. An image forming apparatus, comprising:
the transport device according to claim 6;
an image forming portion that forms an image on the recording medium held by the holding member at an image forming position in a cycle path of the cycle member of the transport device; and
a fixing portion that fixes the image on the recording medium at the fixing position in the cycle path.

18. An image forming apparatus, comprising:
the transport device according to claim 7;
an image forming portion that forms an image on the recording medium held by the holding member at an image forming position in a cycle path of the cycle member of the transport device; and
a fixing portion that fixes the image on the recording medium at the fixing position in the cycle path.

19. An image forming apparatus, comprising:
the transport device according to claim 8;
an image forming portion that forms an image on the recording medium held by the holding member at an image forming position in a cycle path of the cycle member of the transport device; and
a fixing portion that fixes the image on the recording medium at the fixing position in the cycle path.

20. The image forming apparatus according to claim 12, comprising:
a controller that controls the deformation member of the transport device,
wherein the controller causes the deformation member to deform the leading end portion of the recording medium in the thickness direction throughout the width direction when the recording medium has an image on one surface, and
wherein the controller controls the deformation member not to operate the deformation member when the recording medium has no image.
